(19) United States
(12) Patent Application Publication
(10) Pub. No.: US 2011/0097598 A1
(43) Pub. Date: Apr. 28, 2011

(54) LASER-WELDED ALUMINUM ALLOY PARTS AND METHOD FOR MANUFACTURING THE SAME

(76) Inventors: Matthew M. McNutt, Attica, MI (US); Anca Matache, Warren, MI (US); Eric Jay Stiles, Ypsilanti, MI (US)

(21) Appl. No.: 12/914,604

(22) Filed: Oct. 28, 2010

Related U.S. Application Data
(60) Provisional application No. 61/255,715, filed on Oct. 28, 2009.

(51) Int. Cl. B23K 26/00; B32B 15/01

(52) U.S. Cl. 428/650; 219/121.64

(57) ABSTRACT

A method of welding difficult to weld aluminum alloys using a laser welding device with at least 4 kilowatts of power operable at a speed of from about 40 millimeters per second to about 160 millimeters per second with a spot size of about 250 to about 600 microns focused at the surface of the aluminum pieces, without the need for shielding gas or filler wire, and the parts made thereby which are of suitable strength and properties to use as lightweight reinforcement structures, particularly in vehicle interior structures.

### CROSS REFERENCE TO RELATED APPLICATION

This application claims priority from U.S. Patent Application Ser. No. 61/255,715, filed Oct. 28, 2009.

### FIELD OF THE INVENTION

This invention relates to a process for welding difficult to weld aluminum alloys and the parts manufactured thereby. Exemplary parts include any parts which can be manufactured using aluminum alloys, including without limitation, components for automobiles or other vehicles such as interior reinforcement structures for automobiles.

### BACKGROUND

Series 5000 and series 6000 aluminum alloys have traditionally been understood as difficult to weld aluminum alloys, particularly without the use of filler wire or shielding gas, or other chemical or mechanical aids to the welding. Although there may have been some instances where a series 5000 aluminum alloy piece has been successfully welded to another series 5000 aluminum alloy piece using a laser welding device, there are no known processes suitable for remote laser welding of one series 5000 aluminum alloy piece to another, or for laser welding a series 5000 aluminum alloy piece to a series 6000 aluminum alloy piece.

U.S. Pat. Nos. 5,665,255; 5,422,066; 5,874,708; and 5,814,784, appear to disclose methods of laser welding without the use of filler or shielding gas. However, the processes described in these patents all employ particular techniques or particular alloys to facilitate laser welding of the aluminum alloys without the attendant cracking.

U.S. Pat. No. 5,665,255 alleges to solve the cracking problem through the use of an oscillating motion of a laser beam which is superimposed on top of the relative velocity of movement between the laser head and the work piece being welded such that a controlled rate of heating and cooling of the molten metal material is achieved. Lasers such as a neodymium-yag (Nd:Yag) laser are described in the disclosure, and welds such as lap joints and butt joints made according to the method are described.

U.S. Pat. No. 5,422,066 alleges achieving no crack aluminum laser welding by using a pulsed laser to weld a particular non-standard aluminum-base alloy (made according to the disclosed composition). The laser is pulsed by using two low power pulses of the laser for preheating, one high power pulse of the laser for welding and two pulses of decreasing power to reduce the cooling rate. The aluminum-base alloy described for laser welding is intended to replace 2000 or 7000 series alloys.

U.S. Pat. Nos. 5,874,708 and 5,814,784 relate to pre-treatment of an area adjacent to the weld seam of the workpiece using an excimer laser or preheated tool (or another method which results in rapid and massive melting of the Aluminum-based alloy) followed by welding using an infrared laser beam such as a YAG laser, CO2 laser or other CO lasers beginning at the location where the pre-treatment occurred, the laser beam having a diameter equal to or greater than the thickness of the work pieces. The use of heating pads to regulate the rate of cooling of the work pieces is also described. The process is described for use with difficult to weld aluminum alloys, such as those in the 5000 and 6000 series. These patents indicate weld speeds of about 2.5 mm per second, a power of about 1450 watts, a 3 mm thick aluminum plate and a spot size of 3000 microns or greater (3 mm) (See '708 at col. 4, ll. 14-19, and '784 at col. 8, l. 60-col. 9, l. 7).

U.S. Patent Application Publication 2007/0026254 discloses the preparation of the surface of 5000 or 6000 series aluminum-base alloys with the aid of atmospheric pressure plasma and a chemical conversion treatment for producing a conversion coating on the metal, which then facilitates the weldability of the aluminum alloys.

### SUMMARY OF THE INVENTION

The present invention is a method of laser-welding difficult to weld aluminum alloys, and the parts produced thereby, such that the weld strength is comparable to that of welded steel, without using complicated processes and without the need for shielding gas or filler wire. These and other objects, advantages and features of the invention will be more fully understood and appreciated by reference to the following description of the preferred embodiments of the invention.

### BRIEF DESCRIPTION OF THE DRAWINGS

FIG. 1 is a perspective view of a representative part, a vehicle instrument panel reinforcement structure, with various views of the welds performed pursuant to the process described herein exploded away.

FIG. 2 is a perspective view showing the bottom of a representative part, a vehicle instrument panel reinforcement structure, with various views of the welds performed pursuant to the process described herein exploded away.

FIG. 3 is a schematic drawing of a multi-module laser assembly useful in the preferred embodiment.

FIG. 4 is a representation of a fiber laser with butt joined modules, which can be used in the preferred embodiment.

### DETAILED DESCRIPTION OF THE PREFERRED EMBODIMENTS

The welding method described herein has direct application to producing light weight interior structural or frame elements, even using difficult to weld series 5000 and series 6000 aluminum alloy pieces. The welding process, more specifically, but without limitation, can be used for applications such as creating light weight interior reinforcement structures for vehicle bodies, such as instrument panel reinforcements, seat frame reinforcements, center console reinforcements, or other reinforcements for interior structures for vehicles.

Using the welding process described herein to create high-strength aluminum alloy interior body structural reinforcements rather than steel structural reinforcements allows for the production of a lighter weight vehicle, which is thereby capable of obtaining better fuel efficiency. Further, by using aluminum alloys with sufficient strength (such as the series 5000 and series 6000 aluminum alloys), the parts, such as the interior reinforcement structures described herein, have a weld strength that is comparable to parts manufactured using steel and can be suitable for use in automotive or other applications requiring strength and rigidity. The welding method described herein can also be used to weld any other parts using aluminum alloy pieces.

The welding process described herein provides these weight savings while also minimizing the cost impact of production of the lighter weight reinforcement elements. The weight reduction effected by using aluminum alloys rather than steel may be as much as about 40%. Further the cost of consumables per hour of weld time, such as the cost of shielding gasses such as Argon, Helium, Nitrogen, Carbon Dioxide or other inert or semi-inert shielding gasses, using the welding process described herein is considerably less than the cost of consumables per hour consumed in the more traditional Mig welding. The term “shielding gas” as used herein refers to the use of such so called “consumables,” and is not intended to refer to the use of ambient air under pressure. Additionally, due to the ability to weld the aluminum alloy pieces pursuant to the description herein without the use of shielding gas or filler wire, the production costs may be further reduced and more flexibility is provided for the production facilities.

The flexibility provided by the laser welding method described herein includes the ability to weld aluminum alloy pieces remotely, since filler wire and shield gas are not required and a long focal length is obtainable with the laser parameters as described herein. As used herein, “remote welding” is a process where the laser used has a sufficiently long focal length from head to object, that the laser can be placed a sufficient distance from the work piece, to allow the laser beam to be directed and redirected toward the work piece, without interference between portions of the work piece and the laser head. Most preferably, the laser beam is directed and redirected toward the work piece using mirrors and or lenses rather than by moving and repositioning the laser. The focal length of the laser—is preferably from about 150 millimeters to about one meter from the laser welding head, more preferably from about 300 millimeters to about one meter. The laser welding method described herein can be used to create the different types of weld joints which are traditionally produced using laser welding, including, without limitation, butt weld joints, edge weld joints, spot/lap weld joints, lap weld joints, tee weld joints and corner weld joints. The laser welding method described herein is preferably used with aluminum alloy having a thickness in the range of from about 1.0 mm to about 6.0 mm, most preferably from about 1.0 to about 4.0 mm.

A high-powered laser capable of outputting at least 4 kW of power, preferably 6 kW or more of power up to about 10 kW, is used to weld the aluminum alloy pieces together in a traditional weld configuration, which may preferably be a lap weld 40 or an edge weld 42. A preferred laser is a Ytterbium fiber laser, such as the IPG Photonics YLR-10000 with a laser process fiber diameter of 200 μm, and the laser optics set at parameters to allow the welding spot size and focus point described herein. For example, a collimator focal length of 150 mm, and with an object focal length of 300 mm, when used with the IPG Photonics YLR-10000 Ytterbium fiber laser with a fiber diameter of 200 μm are capable of producing about a 400 μm welding spot size and focus point described herein. The object focal length controls the distance of the head of the laser from the work piece.

To provide a high quality, bright laser beam, fiber lasers used for the purposes of this invention may be operative to generate radiation in a single, preferably fundamental mode (SM). High power fiber lasers with a kW output are typically provided with fibers having large-diameter core which can typically support higher order transverse modes (e.g., LP₁₁, LP₂₁, LP₀₂ tc.) in addition to the fundamental mode (e.g., LP₀₁). Such higher order modes (ROMs) propagate in the cladding and core of the fiber and tend to degrade the quality of output optical energy provided by the fiber laser device. The fewer the modes, the higher the quality. Accordingly, the highest possible quality of light can be attained by a fiber emitting radiation in a fundamental mode that is the primary a mode of the core.

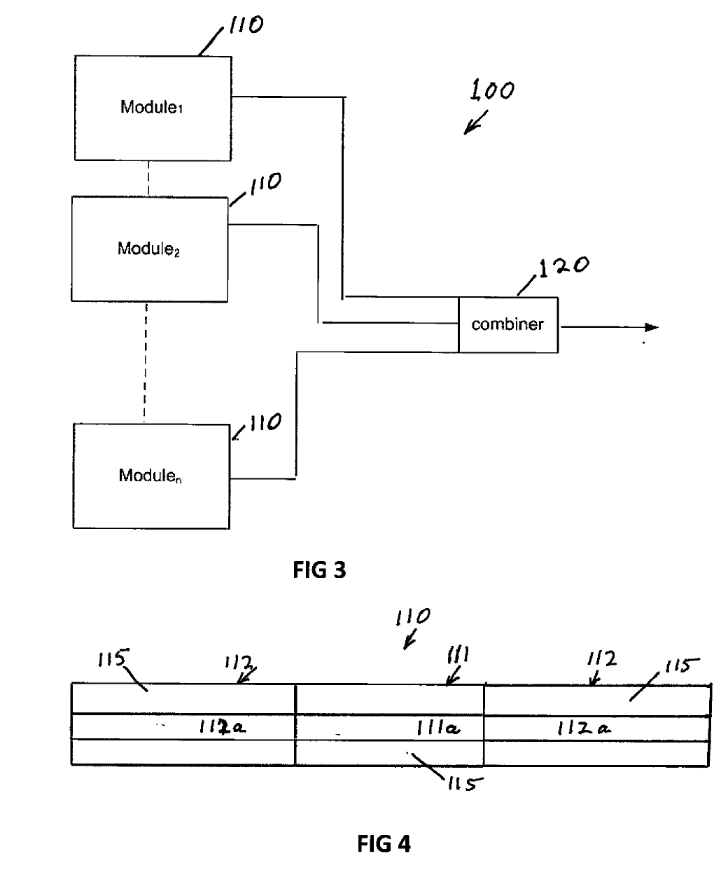

FIG. 3 illustrates one of the possible configurations of a high power fiber laser system 100. Laser 100 is configured with multiple parallel modules 110 each having a single mode fiber laser. The structure of the fiber laser may vary depending on the output power. Utilizing, for example, a single oscillator radiating a 1 kW single mode beam, fiber laser system 100 includes ten single stage modules. If, however, the output power of each oscillator is substantially lower than 1 kW, such as 500 W and lower, the configuration of the module includes a multi-stage laser source known as master oscillator—power amplifier (MOPA) configuration.

Referring to FIG. 4, each module 110 may be structured with a multimode (MM) active fiber 111, and doped with one or more rare earth elements; and single mode (SM) input and output passive fibers 112 which are butt spliced to respective opposite ends of the multimode fiber 111. Multimode fiber 111 comprises a core 111a surrounded by cladding 115, and single mode fibers 112 comprise cores 112a surrounded by cladding 115. The mode can be described as self-consistent electric field distributions in a longitudinal and transverse direction in a fiber. The number of transverse modes, usually referred to as (LP₀₁, LP₁₁, LP₂₁, LP₀₂ etc.), their transverse amplitude profiles and their propagation constants depend on the fiber configuration and on the optical frequency.

Multimode core 111a is configured to support only a fundamental mode at the desired wavelength. To prevent power loss and prevent generation of HOMs at the splices, the cores 111a and 112a of the respective multimode and single mode fibers 111 and 112 are configured with a substantially uniform mode field diameter.

Free ends of the respective output single mode fibers 112 are pressed against one another, heated and tapered to form a so-called combiner 120, diagrammatically shown in FIG. 3 as a rectangle. The configuration of the combiner provides for its output radiation that has a very few modes and can be referred to as the radiation in a substantially fundamental mode. When the operation does not require a high quality beam, laser system 100 may be configured to generate a multimode output radiation, i.e. radiation characterized by tens and even hundreds of modes.

A variety of laser configurations can be used depending on the desired output power and wavelength. In addition to the fiber lasers discussed above, the laser configuration may be selected from solid-state lasers, gas lasers, and dye lasers.

The laser's weld speed in this embodiment may be from about 40 mm/second (0.3 m/minute) to about 160 mm/second (0.96 m/minute), preferably about 50 mm/second (0.3 m/minute) to about 120 mm/second (0.72 m/minute), with a weld spot size of about 250 to about 600 μm, preferably about 400 μm focused at about the surface of the pieces to be welded. At a laser power of about 6 kW, a weld speed of 100 mm/sec is optimal without the use of shielding gas or filler wire. However, it is contemplated that when higher powered lasers are used to weld the material, the maximum weld speed, workable range of weld speeds and optimal weld speed will increase. Additionally, if a larger welding spot size is used, to continue to achieve the same weld strength, either a higher powered laser must be used or a slower weld speed.

When the welding parameters described in this embodiment are used, even with difficult to weld series 5000 and series 6000 aluminum alloys, shielding gas and filler wire are not required to create welds with a weld strength that is comparable to steel welds, despite conventional expectations that the weld would exhibit high porosity, cracking and indentation when welded without the use of shield gas or filler wire.

According to one embodiment of the present invention, at least two series 5000 aluminum alloy pieces are welded together according to the welding parameters described herein, preferably series 5052 stampings or extrusions with a thickness preferably of from about 1.5 mm to about 2.0 mm. Each piece being welded may or may not have the same thickness as the adjacent piece. The method described herein is further suited to remote welding, such that the series 5000 aluminum alloy pieces can be welded using a remote welding process.

In another embodiment of the invention, at least one series 5000 aluminum alloy piece, preferably a series 5052 aluminum alloy stamping or extrusion, and at least one series 6000 aluminum alloy piece, preferably a series 6061 or 6062 aluminum alloy stamping or extrusion, are welded together according to the welding process described herein. The aluminum alloy pieces preferably both have a thickness from about 1.5 mm to about 2.0 mm. Each piece being welded may or may not have the same thickness as the adjacent piece.

It is also believed that the process described herein can be used to weld two or more series 6000, preferably series 6061 or 6062, aluminum alloy pieces together without the need for shielding gas or filler wire.

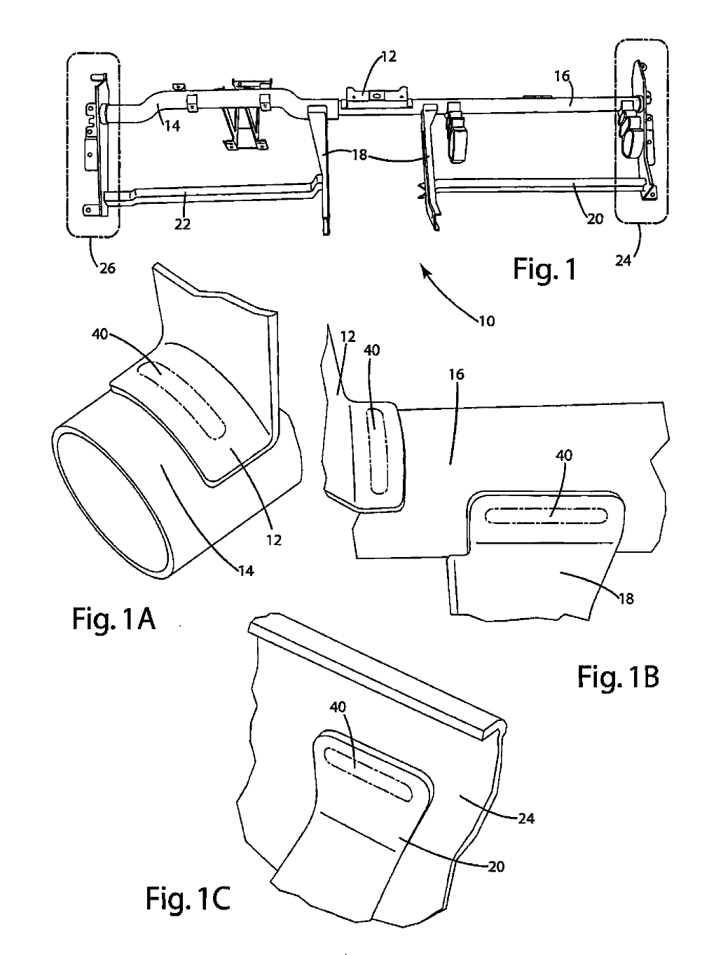

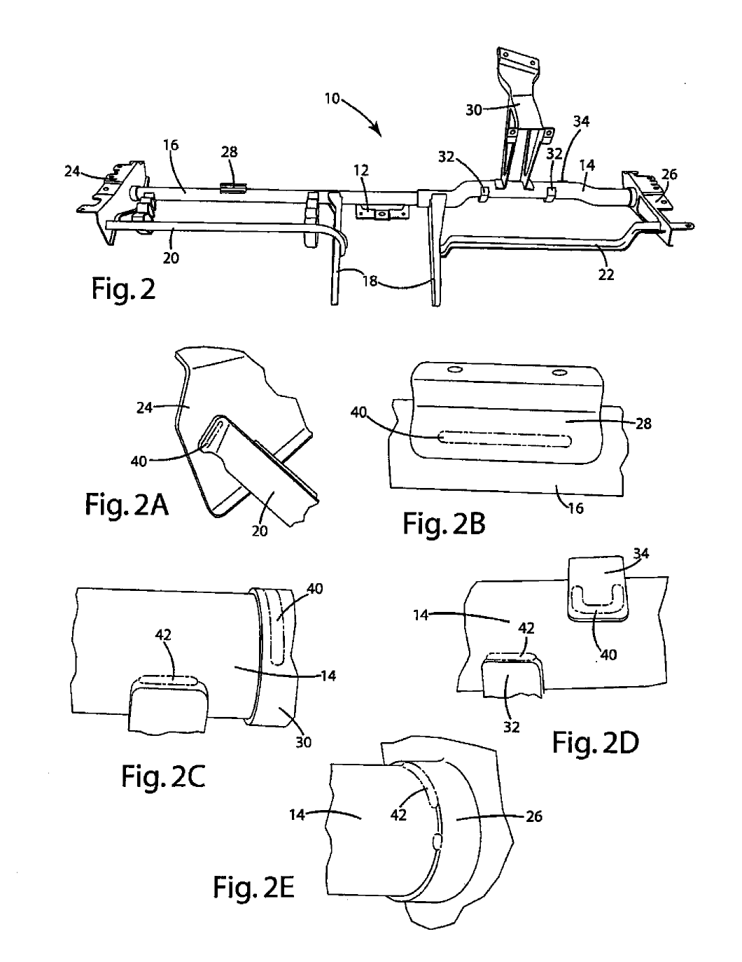

The drawings described herein illustrate parts manufactured using the welding process described herein. FIG. 1 and FIG. 2 both illustrate perspective views of an automobile reinforcement structure, specifically, an instrument panel reinforcement structure 10. FIG. 1 shows, in the close-up figures (FIG. 1(a), FIG. 1(b) and FIG. 1(c)), three lap weld joints 40 that are used to connect various portions of the instrument panel reinforcement structure 10. As shown in FIG. 1(a), a lap weld 40 can be used to connect a stamped flange end of a substrate locator bracket 12 to the driver side upper frame tube 14. The passenger side upper frame tube 16 is connected in line with the driver side upper frame tube 14, to extend the horizontal width of the dashboard. Dashboard center supports 18 extend downward from the upper frame tubes 14, 16, near the medial portions of each of the upper frame tubes 14, 16 and are connected to the upper frame tubes 14, 16 as shown in FIG. 1(b), using lap weld joints 40. The dashboard center supports 18 connect at their lower end to the lower rail 20, 22 frame portions, which extend outward from the dashboard center supports 18, and in FIG. 1(c), a lap weld 40 is also shown to connect the passenger side lower rail 20 to the passenger side cowl bracket 24, which braces the passenger side upper tube 16 and the passenger side lower rail 20 by connecting to each 16, 20 at its outer end and stabilizing it. Similarly, a driver side cowl bracket 26 is provided to brace the driver side upper tube 14 and the driver side lower rail 22. Additional brackets and supports, as appropriate to the dashboard structure and instrument panel placement, can be welded to the frame structure described herein, using the welding method described herein.

FIG. 2, which shows the instrument panel reinforcement structure 10 from the bottom, illustrates both lap weld 40 and edge weld 42 configurations. FIGS. 2(a) and 2(b) illustrate lap welds 40 used to connect the passenger side lower rail 20 to the passenger side cowl bracket 24 and to connect a bracket 28 to the passenger side upper frame tube 16, respectively. FIG. 2(c) illustrates both an edge weld 42 and a lap weld 40 used to connect an upper plenum bracket 30 to the driver side upper frame tube 14 and a steering column bracket 32 to the driver side upper frame tube 14. FIG. 2(d) also illustrates both a lap weld 40 and an edge weld 42 used to connect an upper cluster attachment bracket 34 and a steering column bracket 32 to the driver side upper frame tube 14. FIG. 2(e) illustrates an edge weld 42 connecting the driver side upper frame tube 14 to the side-supporting driver side cowl bracket 26.

Although shielding gas and filler wire are not required to weld according to the process described herein, it is contemplated that the use of shielding gas or filler wire could be used with the parameters described herein. Additionally, the welding process described herein could be combined with other traditional joining methods such as the use of Mig welding, adhesive bonding, mechanical joining, friction stir welding or any combination of the above.

By the foregoing description, it will be readily appreciated by those skilled in the art that modifications may be made to the invention without departing from the concepts disclosed herein. Such modifications are to be considered as included in the invention and the claims, unless the claims by their language expressly state otherwise.

1. A method for welding aluminum alloy pieces comprising the steps of:
positioning a first aluminum alloy piece and a second aluminum alloy piece in position for welding, wherein the first and second aluminum alloy pieces comprise material chosen from the group consisting of series 5000 aluminum alloys and series 6000 aluminum alloy;
welding the first and second aluminum alloy pieces together with a laser welding device with a focal length sufficient to enable remote welding.

2. The method of welding aluminum alloy pieces of claim 1, wherein the welding is done without the use of a shielding gas or a filler wire.

3. The method of welding aluminum alloy pieces of claim 1, wherein the first and second aluminum alloy pieces are series 5000 aluminum alloys.

4. The method of welding aluminum alloy pieces of claim 1, wherein the focal length of the laser is greater than about 300 microns.

5. The method of welding aluminum alloy pieces of claim 1, wherein the first aluminum alloy piece is series 5000 aluminum and the second aluminum alloy piece is series 6000 aluminum.

6. The method of welding aluminum alloy pieces of claim 1, wherein the laser welding device is selected from the group consisting solid-state lasers, gas lasers, dye lasers, and fiber lasers and a combination thereof, the laser source being operative to generate radiation at a power output of from about 4 kilowatts to about 10 kilowatts.

7. The method of welding aluminum alloy pieces of claim 6, wherein the laser welding device is operated at a weld speed of from about 40 millimeters per second to about 160 millimeters per second, a weld spot size of about 250 to about 600 microns.

8. The method of claim 6, wherein the radiation is substantially in a fundamental mode.

9. The method of claim 8 wherein the fiber laser is configured with:
a plurality of modules each having a multimode doped fiber, which is configured to generate single mode radiation at a desired wavelength, and a single mode output fiber; and
a combiner configured of the single mode output fibers of respective modules and operative to generate radiation in a substantially fundamental mode.

10. The method of claim 10 wherein the multi-mode and single mode fibers of each module are configured with respective mode field diameters substantially matching one another.

11. The method of welding aluminum alloy pieces of claim 1, wherein the first and second aluminum alloy pieces each have a thickness of from about 1 millimeter to about 6 millimeters.

12. The method of welding aluminum alloy pieces, comprising:
providing a first aluminum alloy piece and a second aluminum alloy piece in position for welding, wherein the first aluminum alloy piece comprises series 5000 aluminum alloy, and the second aluminum alloy piece comprises series 6000 aluminum alloy;
welding the first and second aluminum alloy pieces together with a laser welding device having a power output of about 4 kilowatts or greater, operated at a weld speed of from about 40 millimeters per second to about 160 millimeters per second, and a weld spot size of from about 250 to about 600 microns.

13. The method of welding aluminum alloy pieces of claim 12, wherein the focal length of the laser welding device is greater than about 150 millimeters.

14. The method of welding aluminum alloy pieces of claim 12, wherein the weld speed of the laser welding device is from about 50 millimeters per second to about 120 millimeters per second.

15. The method of welding aluminum alloy pieces of claim 12, wherein the weld spot is focused on about the surface of the first aluminum piece.

16. The method of welding aluminum alloy pieces of claim 12, wherein the first aluminum alloy piece has a thickness which is different than that of the second aluminum alloy piece.

17. The method of welding aluminum alloy pieces of claim 12, wherein the power output of the laser welding device is about 6 kilowatts or greater and the weld speed is about 100 millimeters per second.

18. The method of welding aluminum alloy pieces of claim 17, wherein the focal length of the laser welding device is greater than about 300 millimeters.

19. A lightweight structure comprising:
a first member, comprising a material chosen from the group consisting of series 5000 aluminum alloy and series 6000 aluminum alloy; and
a second member, comprising a material chosen from the group consisting of series 5000 aluminum alloy and series 6000 aluminum alloy;
wherein the first member and the second member are welded together according to the method of claim 1.

20. The lightweight structure of claim 19, wherein the first and second members are welded according to the method of claim 2.

21. The lightweight structure of claim 19, wherein the first and second members are welded according to the method of claim 3.

22. The lightweight structure of claim 19, wherein the first and second members are welded according to the method of claim 6.

23. The lightweight structure of claim 19, wherein the first and second members are welded according to the method of claim 11.

24. The lightweight structure of claim 19, wherein the first and second members are welded according to the method of claim 12.

25. The lightweight structure of claim 19, wherein the first and second members are welded according to the method of claim 13.

26. The lightweight structure of claim 19 comprising:
said first member comprising series 5000 aluminum alloy; and
said second member comprising series 6000 aluminum alloy.

27. The lightweight structure of claim 26, wherein the first and second members are welded according to the method of claim 15.

28. The lightweight structure of claim 26, wherein the first and second members are welded according to the method of claim 16.

29. The lightweight structure of claim 26, wherein the first and second members are welded according to the method of claim 19.

30. The lightweight structure of claim 26, wherein the first and second members are welded according to the method of claim 21.

31. The lightweight structure of claim 26, wherein the lightweight structure comprises a reinforcement for an automobile interior component.

32. The lightweight structure of claim 31, wherein the automobile interior component is an instrument panel.

33. The lightweight structure of claim 31, wherein the automobile interior component is a console.

34. The lightweight structure of claim 31, wherein the automobile interior component is a seat frame.

35. The lightweight structure of claim 31, wherein the automobile interior component is a instrument panel beam.

36. The lightweight structure of claim 19, wherein the lightweight structure comprises a reinforcement for an automobile interior component.

37. The lightweight structure of claim 36, wherein the automobile interior component is an instrument panel.

38. The lightweight structure of claim 36, wherein the automobile interior component is a console.

39. The lightweight structure of claim 36, wherein the automobile interior component is a seat frame.

40. The lightweight structure of claim 36, wherein the automobile interior component is a instrument panel beam.

41. A method of welding aluminum alloy pieces comprising the steps of:
positioning a series 5000 first aluminum alloy piece and a series 6000 second aluminum alloy in position for welding;
laser welding the first and second aluminum alloy pieces using a laser welding device without shielding gas, filler wire, chemical modification of the alloy pieces, cladding the alloy pieces, oscillating the location of the beam on the work piece, or using a pulsed laser arrangement.
